(19) United States
(12) Patent Application Publication
(10) Pub. No.: US 2003/0132341 A1
(43) Pub. Date: Jul. 17, 2003

(54) Device by a horizontally and vertically flying aircraft

(76) Inventors: Geir O Glomstad, Biri (NO); Thor Hukkelas, Kongberg (NO); Ragnvald Otterlei, Kongberg (NO)

Correspondence Address: SIERRA PATENT GROUP, LTD., P O BOX 6149, STATELINE, NV, 89449, US

(21) Appl. No.: 10/203,198

(22) PCT Filed: Jan. 23, 2001
(86) PCT No.: PCT/NO01/00023

(51) Int. Cl. B64C 27/52

(52) U.S. Cl. 244/17.25

(57) ABSTRACT

An arrangement for a horizontally and vertically flying aircraft of the type that for vertical flight has rotors that form a lifting area such as in a helicopter, and where the rotors are retracted within a rotor disc (4) during horizontal flight. The rotors (8) are supported with fixed pitch in the rotor disc (4). The centre point of the lifting area is arranged to be capable of being shifted in an xy plane, or means are provided to be brought at determined points within the lifting area of the rotor disc (4) to break the lifting capabilities in the effective rotor disc for manoeuvring and counteracting differential lift during propulsion of the aircraft in vertical flight and on the transition from vertical to horizontal flight.

The present invention relates to an arrangement for a horizontally and vertically flying aircraft of the type disclosed in the preamble of claim 1.

A helicopter is a complex aircraft, capable of flying vertically, forwards, backwards and sideways, and also of hovering (remain stationary in the air). These characteristics notwithstanding, a helicopter operates according to the same basic principles as a fixed-wing aircraft. Like an ordinary aeroplane, a helicopter flies on the basis of wings having a given surface profile that utilise air streams to create lift. In the case of a helicopter, this primary profile (lifting profile) is associated with the main rotor.

However, the principal disadvantages of a helicopter are the limitations of the rotor structure with regard to functioning at high air speeds and thus the limited possibility of reaching a high speed, and also the fact that the rotor is a complex, vulnerable structure with high maintenance requirements.

Drag or resistance to motion will always seek to brake the main rotor of a helicopter on speed increases and changes in angle of attack. This results in a limitation of air speed and an increase in fuel consumption.

Accordingly, one of the objects of the present invention is to neutralise or reduce the aforementioned drag.

U.S. Pat. No. 2,684,212 describes an aircraft design where an attempt is made to exploit the advantages of a helicopter and at the same time have propulsion like that of an ordinary aeroplane. The rotors are retracted within a rotor disc for forward flight, thereby avoiding the disadvantages of the rotor in connection with forward flight. The pitch of the rotor blades can be varied as in a conventional helicopter, which is favourable as regards stabilisation, but has other drawbacks as described in detail below, and which the present invention aims to avoid.

Aerodynamic forces are concentrated in the rotor blade centre of pressure of a helicopter. Changes in these forces also lead to a change in the centre of pressure, resulting in potentially dangerous instability.

It is also an object of the present invention to stabilise the rotor system in a rigid structure and control aerodynamic variations of the forces.

Stalling occurs in the retarding half of the rotor disc at an excessively high speed and sharp angle of attack, resulting in highly dangerous instability and lack of control, chiefly in the form of a stall of the craft (the nose is arising upwards).

Accordingly, it is an object of the present invention to ensure that rotor blades are withdrawn from the surrounding air masses in order to attain higher speed and safer flying.

Coning occurs as a consequence of the resultant force between the lifting force (which increases as the distance from the centre of the rotor axis increases) and the centrifugal force. A potentially different resultant in the different blades will cause negative balance between the blades and vibrations or loads. Furthermore, the displacement of the centre of gravity on account of hinged rotor blades will cause imbalance, vibrations and heavy loads in the rotor system.

The aforementioned problems can be avoided by a structure having rigid rotor blades according to the present invention.

When a helicopter rotor rotates, it will apply a torque to the actual aircraft body or fuselage. The tail rotor compensates for this torque. The disadvantages of this solution are high energy consumption and a tendency for the whole helicopter to move in the working the tail rotor. For this reason, it is desirable to provide a technique for the elimination of torque without contact with the surrounding air masses.

One of the consequences of the fact that the whole length of the rotor blade works in the air masses in conventional known helicopters is that it will be necessary to have a particularly accurate (costly) design and production. For this reason, one of the objects of the present invention is to use only that part of the rotor blade that gives best lifting capabilities, which will result in a simpler structure.

The sections of the rotor disc in a conventional helicopter represent different lifting capabilities in relation to the distance from the centre of rotation. When there is an increase in speed, drag may even occur on one side of the inner section so that uneven lift in relation to the surrounding air masses must be corrected continuously.

However, in the present invention only the outer section of the rotor disc is used for lift and manoeuvring. The inner sections are encased within the aircraft structure and pull the outer section away from the air masses when there is an increase in speed. Lift is then transferred to a stable, fixed-wing structure.

A rotor system functions optimally (cost-effectively) at about 7-9 m/s propulsion speed, and speed increases result in poorer fuel economy. Vibrations and roll tendencies along the longitudinal axis are also often associated with an increase in speed because of an intensification of downward air streams in the rotor disc.

It is an object of the present invention to provide more cost-effective flying at higher speeds by not using the rotor blades for manoeuvring, but by using wings at high speed.

Ground resonance produces severe and damaging vibrations during landing and take-off when the rotor structure comes into imbalance during the establishment of the Coriolis effect. To avoid this, a rotor structure having rigid rotor blades is required.

Helicopters are unstable in the longitudinal direction because of the solution of the working area of the tail rotor pitch in surrounding, changing air masses, and therefore there is a need for a structure that offsets the torque independent of the surrounding air masses.

The rotor head/gear transmission is a very complex structure, which in a helicopter is exposed to great loads. The rotor head is especially vulnerable to sudden displacements of load. For this reason, it is desirable to assign the load application points of the rotor structure to a non-critical part of the aircraft structure.

It is therefore an object of the present invention to provide a less vulnerable structure for the purpose of offsetting the torque, and also to give better manoeuvring capabilities about the vertical axis of the aircraft.

Because of the special characteristics of the structure of a helicopter, it is difficult/uneconomical to reach great flying altitude, which in many situations is desirable.

Accordingly, it is an object of the present invention to provide a structure that permits effective flying altitude on a line with ordinary types of aircraft.

The aforementioned is provided by means of an arrangement of the type mentioned in the introduction, the characteristic features of which are set forth in claim 1. Additional features of the invention are set forth in the other, dependent claims.

Thus, the aircraft according to the present invention has vertical take-off and landing characteristics (VTOL) on the same lines as a helicopter, and therefore requires little landing space.

It is possible to reach high horizontal speed without diminishing the flying characteristics by retracting rotors within a closed disc.

The aircraft will have just as good manoeuvring characteristics as helicopters at low speeds.

The structure is less vulnerable to loads and external stresses than a conventional rotor structure.

The structure retracts the rotors at low speeds, and does not represent a safety risk to personnel involved in ground operations.

The rotor blades are protected 100% during long ground stops, and this will provide reduced vulnerability of easily damaged rotors.

The structure is flexible and can be adapted to different types of flying operations and missions.

CCR (Circulation Controlled Rotor—release of jet stream at the trailing edge of the rotor blades—ref. NASA/X-wing +HD2D)—allows the tail-rotor to be eliminated, and also results in a total reduction in weight.

CCR—“blown rotor blades” allow lower rotor speed, as the jet stream at the trailing edge of the rotor is blown across the following blade.

At the transition to pure thrust in the FCR-system (Floating and Centrifugal operated Rotordisk), the stalling of the effective rotor disc at increasing horizontal speeds is avoided by the gradual withdrawal of the rotor blades from the surrounding air masses.

On increasing horizontal speed, the rotor blades will be retracted within the closed rotor disc and the jet turbines will produce progressively more thrust. The aerodynamic structure of the craft begins to bear more.

At higher horizontal speed, the circular wing (closed rotor disc) and the wings take over lift and manoeuvring completely. Conventional steering controls are used, i.e., there is a transfer of power from the rotor system (CCR) to pure thrust for propulsion, and the craft now flies in principle like an ordinary high-speed jet-propelled structure.

In what follows the invention will be described in more detail with reference to the drawings, wherein:

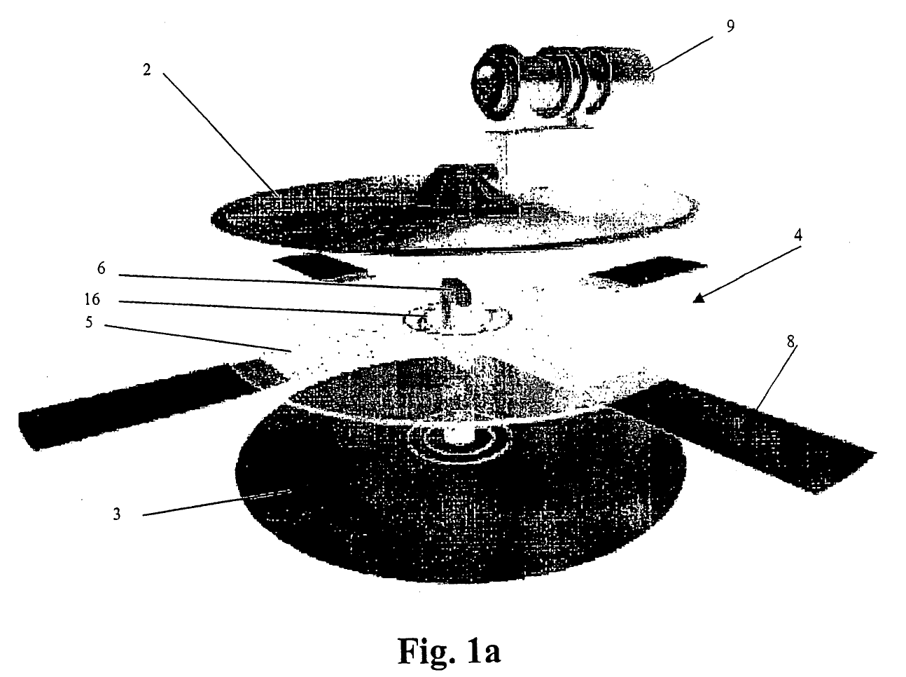

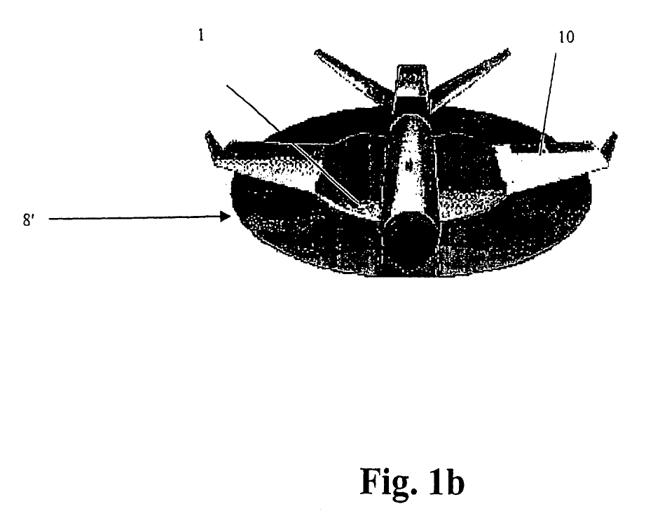

FIG. 1a is a schematic exploded view of a solution according to the present invention;

FIG. 1b shows an aircraft equipped with the system according to the present invention, where the aircraft is in lift mode;

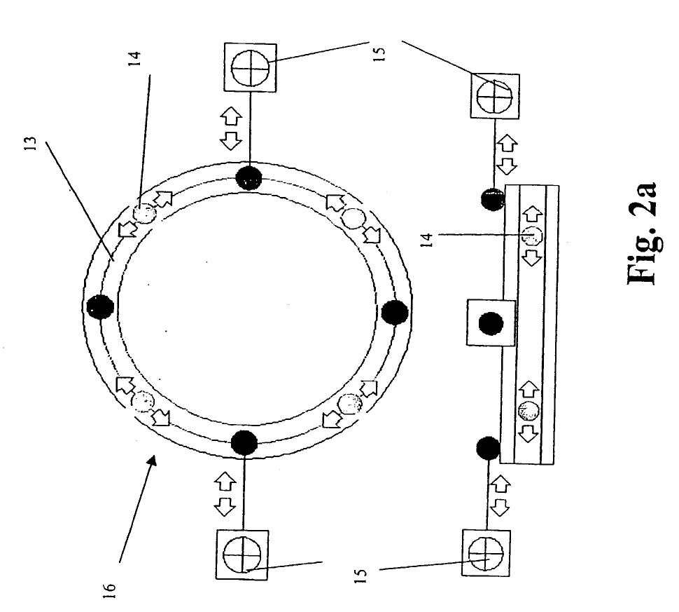

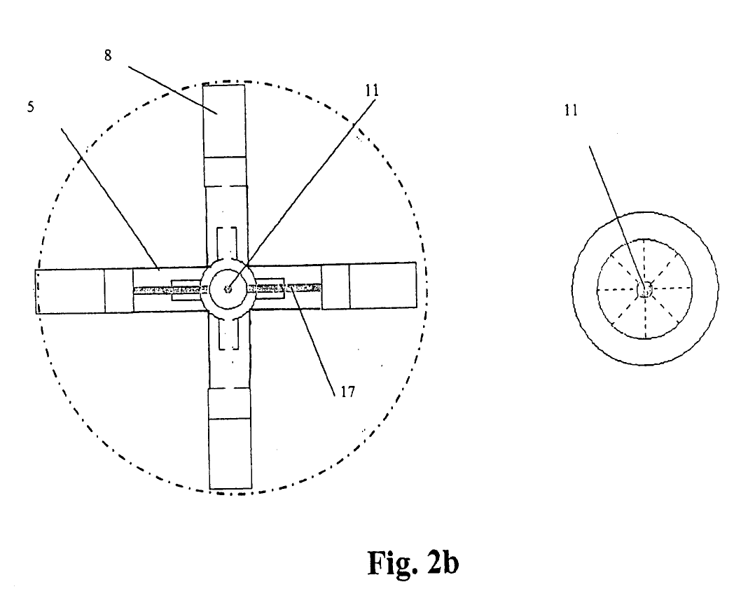

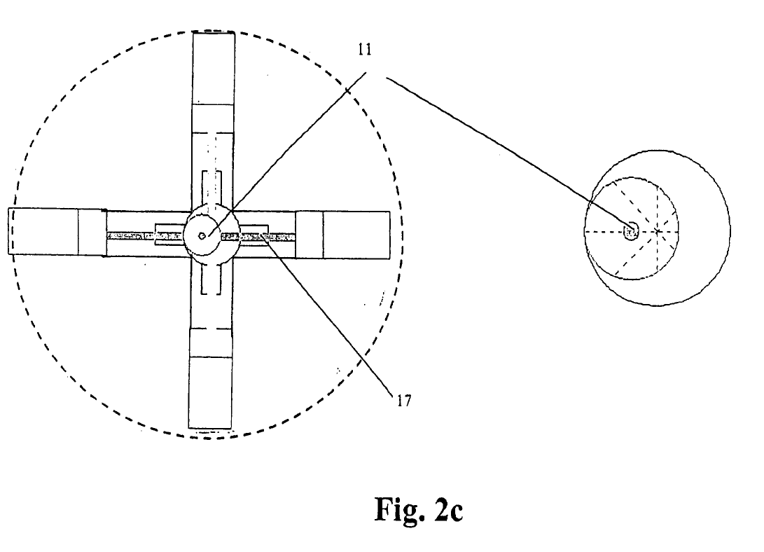

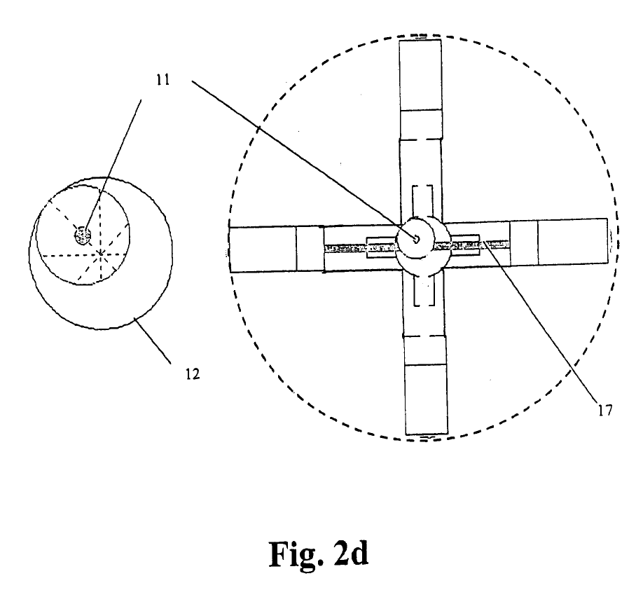

FIGS. 2a,b,c,d show examples of control of different lifts in connection with one embodiment.

FIG. 1a is a schematic exploded view of a solution according to the present invention, which shows a circular aerofoil 1 (se FIG. 1b) consisting of a top section 2 and a bottom section 3 that accommodates a rotor disc (Floating and Centrifugal operated Rotordisk “FCR”) 4 and the rotor 8 receiving section 5. Top and bottom sections 2, 3 are securely connected in the centre using a circular fastening (CW-connector) 6, and rotationally connected in slide tracks on the upper side and the underside of the four receiving sections 5. Connected to the top section 2 are the fuselage, wings 10, turbojet/turbofan, drive gear and side rudder, cf. FIG. 1b. Connected to the bottom section 3 are landing gear and payload. FIG. 1b shows an aircraft equipped with the system according to the present invention, where the aircraft is in lift mode, with rotating rotors 8′.

The CCR pressure chamber for the supply of gas to the rotors lies around the circular fastening 6.

The rotors 8 can be driven according to the CCR-principle described above, where gas/pressure from the turbojet/turbofan engine 9 is fed into the chamber of the rotor disc 4 which forms a control disc and then into the rotor bars 17 of the rotor blades 8 before release into the outermost trailing edge of the rotors. Besides accelerating the rotor blades 8, the rate of this gas flow will increase the lifting capability of a following rotor blade at moderate speed. Tests have shown sufficient lifting capability even though the rotor blade has a wholly symmetrical profile, approximately a flat oval shape. This means in principle that the rotor blade is stable like a fixed wing independent of the direction of the air stream. The system has also been tested by NASA-Sikorsky; X-wing/stopped rotor.

FCR (Floating and Centrifugal operated Rotordisk) (cf. FIGS. 1a and 1b) is based around a design principle where the rotors 8 for vertical lift are retracted and concealed within a circular closed wing/rotor disc 2, 3, 4 during horizontal flight.

Inward/outward manoeuvring and running of the rotor blades 8 are operated using a jet turbine 9, which also provides thrust in flight.

FCR operates with the rotors 8 at a fixed angle, rigid rotors 8 and synchronously adjustable blade length related to a non-physical centre of rotation in the closed rotor disc 4, i.e., the part of the rotor blades 8 that rotates (blade disc 8′) and is outside the rotor disc 4, and forms a lifting area so that the centre point of the lifting area forms a non-physical centre of rotation.

The FCR-system makes use of the most effective lifting area. Lifting capability is produced by adjusting the effective length of the rotor blades 8, and hence the air stream around the rotor blades.

FCR produces lift only in the outermost ⅓ of the rotor disc radius (blade disc), but nevertheless utilises 65% of the effective lifting area of the rotor disc.

The operating principle of the invention will be described in more detail below with the aid of a possible embodiment of the invention and with reference to the figures.

When the aircraft is stationary on the ground, the rotors 8 are retracted within the closed rotor disc 4. When the aircraft is started, the jet turbine 9 of the engine begins to accelerate the rotor blades 8 around an imaginary centre of rotation with the aid of CCR (Circulation Controlled Rotor—release of jet stream at the trailing edge of the rotor blades, cf. NASA/X-wing +HD2D).

The CCR-principle allows offset of torque and elimination of the tail rotor, in addition to permitting lower speed of rotation of the effective blade disc. An increase in the rotational speed of the rotor disc and thus an increase of the centrifugal force accelerates the rotor blades 8 out of the closed rotor disc 4. The effective blade disc 8′ with rotor blades 8 (see FIG. 1b) generates lift and the aircraft takes off vertically.

The resultant for lifting capability and centrifugal force will be approximately equal to the perpendicular production of lift, due to the use of rigid rotor blades 8.

FCR permits a floating effective rotor blade disc 8′, due to the imaginary centre of rotation (centre point of the lifting area). The displacement of the effective blade disc 8′ relative to the closed will result in different production of lift for the aircraft.

For tilting backwards and to the sides, the effective rotor disc is moved correspondingly in the opposite direction to the direction in which the aircraft is to move.

The torque of the aircraft about the vertical axis is controlled by means of thrusted vectoring at the rear edge of the engine.

On the transition from lifting to propulsion, this means that the effective blade disc 8′ is moved backwards and gradually sideways to counterbalance increasing differential lifting capability as the horizontal speed increases, thereby avoiding stalling. Possible technical solutions are described later in the description.

The rotor blades 8 are retracted within the closed rotor disc 4 and the jet turbines 9 produce progressively more thrust. The aerodynamic structure of the aircraft begins to bear more.

At higher horizontal speed, the circular wing (closed rotor disc) 2, 3, 4 and the wings 10 take over lift and manoeuvring completely. Ordinary rudder controls are now used.

A transfer of power is made from the rotor system (CCR) to pure thrust for propulsion. The craft now flies in principle like an ordinary high-speed jet-propelled structure. That described in the above is control (manoeuvring and counteracting differential lift during propulsion) of the fuselage of the aircraft during lift and on the transition to propulsion by displacing the effective lifting area about an imaginary centre. As an alternative to the use of CCR, the system can also be controlled and operated mechanically.

However, this control could be provided in other ways, as for instance in that the centre of rotation is fixed and the effective lifting area (blade disc) is fixed (non-displaceable) and where there are provided physically adjustable means that actuate the effective part of the effective area of the blade disc. Such solutions may be that the top section 2 and the bottom is section 3 of the rotor disc 4 are arranged to be movable in the xy-plane. Another example of such control is that means are provided which are brought out at determined points to break the lifting capabilities in the effective blade disc and thus in tilting of the craft. These means may, for example, be formed by parts of the top and bottom sections 2, 3 of the rotor disc 4 in the form of, for instance, small adjustable bars.

An embodiment of the invention for control of different lifts will be described in more detail below with reference to FIGS. 2a, b, c, and d.

In the centre of the rotor disc 4 there may be arranged a circular, floating control disc 16 that is freely positioned under/over/in the middle of the fastening 6 (CW-connector). The control disc 16 can be connected to four servos or actuators 15 that move the control disc 16 in all directions within a limited, circular zone 12. This control moves the four rotor blades 8 individually along the longitudinal axis, without changing the circular symmetry of the rotor disc or the position of the rotor receiving sections. In practice, the centre point 11 of the rotor disc or blade disc is moved (imaginarily) relative to the fastening 6. The centrifugal force in each rotor set cancel one another out in the centre of the rotor set, which is why servocontrol is not heavy.

The rotor blades 8 can be moved by means of, for example, actuators 15, in their longitudinal direction in the receiving section 5 of the rotor disc 4. The rotor shaft of the rotor blades 8 may be anchored in a circular groove 13 at the outer edge of the control disc 16, and can move along said groove 13. On rotation of the rotor blades 8, the propulsion will result in a displacement of the anchoring position in the control disc 4 according to the position of the control disc relative to the centre point 6 of the fastening, i.e., a symmetrical displacement along the rotor blades' 8 own longitudinal axis.

The control disc 4 may be arranged to be displaceable in an x, y plane with the anchoring axis 6 as starting centre, so that the centre 11 of the control disc 4 can be moved in all directions out from the anchor centre, cf. FIGS. 2a, b, c which show different centre positions. The displacement can be provided by means of the aforementioned four servos or actuators, one for each of the rotor blades, or by two actuators that move the actual control disc in the x- and y-direction respectively.

1. An arrangement for a horizontally and vertically flying aircraft of the type which for vertical flight has rotors that form a lifting area such as in a helicopter, characterised in that the rotors (8) are mounted with fixed pitch in the rotor disc (4), that the centre point of the rotors (8) is arranged to be capable of being shifted in an xy-plane.

2. An arrangement according to claim 1, characterised in that the centre point of the lifting area is formed by a control disc, the shaft of the rotors (8) being connected to the control disc, and that the control disc is connected to actuators controllable to and from in the x-direction and the y-direction respectively in the horizontal plane of the aircraft.

3. An arrangement according to claim 1, characterised in that displacement of the centre point of the lifting area is produced in that parts of the rotor blades (8) are retracted gradually within the rotor disc (4) by means of actuators (15) connected to respective rotor blade shafts when the rotor blades (8) on rotation approach the area where reduced lift is desirable.

4. An arrangement according to claim 1, characterised in that in the centre of the rotor disc (4) there is arranged a circular, floating control disc (16) that is positioned freely under/over/in the middle of a fastening (6) (CW-connector) for the top and bottom sections (2, 3) of the rotor disc (4).

5. An arrangement according to claims 3-4, characterised in that the rotor blades (8) are arranged to be displaceable in the longitudinal direction of the receiving section (5) of the rotor disc (4) and on the rotor shaft that is anchored in a circular groove (13) at the outer edge of the control disc (16), and can move along said groove (13) so that on rotation of the rotor blades (8) the propulsion will result in a displacement of the anchoring position in the control disc (16) depending on the position of the control disc (16) relative to the centre point (6) of the fastening, i.e., a symmetrical displacement along the rotor blades' (8) own longitudinal axis.

6. An arrangement according to claim 5, characterised in that said means are formed in that the top (2) and bottom (3) sections of the rotor disc (4) are arranged to be shiftable in the xy-plane.

7. An arrangement according to claims 5, characterised in that said adjustable means are formed by parts of the top and bottom sections (2, 3) of the rotor disc (4) in the form of small adjustable bars.
